(19) United States
(12) Patent Application Publication
(10) Pub. No.: US 2009/0142256 A1
(43) Pub. Date: Jun. 4, 2009

(54) METHOD FOR PRODUCING A NANOSTRUCTURED MATERIAL

(75) Inventors: Hiroaki WAKAYAMA, Nagoya-shi (JP); Yoshiaki FUKUSHIMA, Aichi-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOYOTA CHUO KENKYUSHO, Aichi-gun (JP)

(21) Appl. No.: 12/323,661

(22) Filed: Nov. 26, 2008

(30) Foreign Application Priority Data
Dec. 3, 2007 (JP) 2007-312189

(51) Int. Cl. C01G 49/02; C01F 7/20; C01G 33/00

(52) U.S. Cl. 423/630; 423/632; 423/594.17; 977/896

(57) ABSTRACT

A method capable of easily producing a nanostructured material having regular nanoscale arrangement. The method comprises a raw material solution preparation step of preparing a raw material solution by dissolving, in a solvent, a block copolymer comprising a polymer block component “A” and a polymer block component “B” which are immiscible to each other, and an inorganic precursor which coordinates with the polymer block component “A” but does not coordinate with the polymer block component “B”; and a nanostructure-forming step of forming a nanophase-separated structure “10” in which a polymer phase “1A” comprising the polymer block component “A” with which the inorganic precursor is coordinated, and a polymer phase “1B” comprising the polymer block component “B” are regularly arranged by self-assembly. A nanostructured material can be obtained by this method. Moreover, by converting the inorganic precursor to an inorganic component, it is possible to obtain an organic/inorganic nanostructured material “20” comprising a polymer phase “2A” containing the inorganic component and a polymer phase “1B”. Furthermore, by removing the organic component, it is also possible to obtain an inorganic nanostructured material “30”.

The present invention is based on Japanese Patent Application No. 2007-312,189, filed on Dec. 3, 2007, the entire contents of which are incorporated herein by reference.

### BACKGROUND OF THE INVENTION

1. Field of the Invention

The present invention relates to a method for producing a nanostructured material having regular nanoscale arrangement.

2. Background Art

It is known that, like multi-layered materials having repeated structure of several to several tens of nanometers, nanostructured materials having regular nanoscale arrangement have different properties from those of ordinary materials. A lot of nanostructured materials which have attained unprecedented properties by control or formation of nanostructure have been proposed so far.

For example, nanostructured materials having multi-layered structure are produced by a method of exfoliating layered crystal and depositing one layer by one layer by the layer-by-layer method (the LBL method), a method of layering a thin film by thin film forming technique such as sputtering, and so on.

Furthermore, Patent Document 1 discloses a method for producing hollow polymeric capsules having a multi-layered structure. In the production method described in Patent Document 1, first, the surface of uncharged microcrystals is coated by self-assembly of charged surfactant molecules. Coating the surface with the surfactant molecules makes it possible to subsequently adsorb and deposit polyelectrolytes. Each polyelectrolyte layer deposited has an opposite charge to that already adsorbed. Then, by removing the encapsulated uncharged microcrystals by dissolving them, hollow polymeric capsules having a multi-layered structure can be obtained.

In Patent Document 2, a composition comprising poly(methylphenylsilane)/3-methacryloxypropyltriethoxysilane block copolymer (P(MPS-co-MPTES)) and Ti(OC₂H₅)₄ is coated on a surface of a substrate and then heated, thereby conducting a sol-gel reaction. By subsequently decomposing the polysilane segment and removing the decomposed materials with a solvent, an inorganic porous thin film is obtained on the substrate.

[Patent Document 1] United States Patent Application Publication No. 2002/0187197

[Patent Document 2] Japanese Unexamined Patent Publication No. 2003-327782

However, in the methods using the LBL method or the thin film forming technique, since a multi-layered structure is formed by layering one layer by one layer, procedures are complicated, especially when different kinds of materials are used in every neighboring two layers. Moreover, since there are materials having crystal structure which cannot easily be exfoliated, or materials which cannot be formed into thin films, the kind of materials to which these methods are applicable is limited.

Also in Patent Document 1 above, since a multi-layered structure is formed by depositing oppositely charged polyelectrolyte layers one layer by one layer, procedures are complicated. Moreover, since polyelectrolyte layers are deposited by adsorption, the abovementioned hollow polymeric capsules have a multi-layered structure but the degree of regularity is low.

Moreover, in Patent Document 2 above, since a hybrid of (P(MPS-co-MPTES)) and titanium oxide is formed, a regularly arranged structure like a multi-layered structure is not formed. Moreover, since a composite oxide with Si is synthesized, the composition of a material to be obtained is limited.

### BRIEF SUMMARY OF THE INVENTION

The present invention has been made in view of the abovementioned problems. It is an object of the present invention to provide a method capable of easily producing a nanostructured material having regular nanoscale arrangement.

A method of the present invention for producing a nanostructured material comprises a raw material solution preparation step of preparing a raw material solution by dissolving, in a solvent, a block copolymer comprising at least a first polymer block component and a second polymer block component which are immiscible to each other, and an inorganic precursor which coordinates with the first polymer block component but does not coordinate with at least the second polymer block component; and a nanostructure-forming step of forming a nanophase-separated structure in which at least a first polymer phase comprising the first polymer block component with which the inorganic precursor is coordinated, and a second polymer phase comprising the second polymer block component are regularly arranged by self-assembly.

It is known that, for example, a block copolymer comprising two kinds of polymer block components “A” and “B” which are immiscible to each other forms a nanophase-separated structure in which a phase “A” and a phase “B” are spatially separate from each other (self-assembly) by being subjected to a heat treatment at or above a glass transition temperature. The phase-separated structure varies with the molecular weight ratio of the polymer block components. Specifically speaking, when A:B=1:1, a layered lamellar structure is formed. As the molecular weight ratio of A:B becomes smaller or larger than 1:1, the structure varies from a bicontinuous structure in which two continuous phases are mingled with each other to a cylindrical structure and further to a dot structure. It is noted that FIG. 1 shows diagrammatic views of nanophase-separated structures generated from block copolymers. In FIG. 1, shown from left to right are a lamellar structure, a bicontinuous structure, a cylindrical structure and a dot structure, and as you go from left to right, the structures have a higher “A” content.

In the method of the present invention for producing a nanostructured material, the inorganic precursor is regularly arranged on a nanoscale by utilizing the abovementioned self-assembly of the block copolymer. The block copolymer comprising a plurality of polymer block components which are immiscible to each other phase-separates on a nanoscale by self-assembly. By making the inorganic precursor coordinated with a particular polymer block component, in accordance with characteristics of the inorganic precursor, at the time of self-assembly, the inorganic precursor is introduced to the nanophase-separated structure simultaneously with the self-assembly of the block copolymer. As a result, the inorganic precursor regularly arranges itself on a nanoscale.

Moreover, by converting the inorganic precursor to an inorganic component, a nanostructured material in which the inorganic component is regularly arranged on a nanoscale is obtained. That is to say, according to the method of the present invention for producing a nanostructure material, by combining the self-assembly of the block copolymer and coordination characteristics of the inorganic precursor, a nanostructured material in which the inorganic component is regularly arranged can be produced with ease.

### BRIEF DESCRIPTION OF THE DRAWINGS

FIG. 1 shows schematic views of nanophase-separated structures generated from A-B type block copolymers.

FIG. 2 shows schematic views of nanostructured materials formed in a nanostructure-forming step.

FIG. 3 is a scanning electron microscope image, as a substitute for a drawing, of an iron oxide coating film produced by the method of the present invention for producing a nanostructured material.

### DETAILED DESCRIPTION OF THE INVENTION

Hereinafter, best mode for carrying out the method of the present invention for producing a nanostructured material will be described.

The method of the present invention mainly comprises a raw material solution preparation step and a nanostructure-forming step. The respective steps will be described below.

[Raw Material Solution Preparation Step]

The raw material solution preparation step is a step of preparing a raw material solution by dissolving a block copolymer and an inorganic precursor in a solvent.

The block copolymer comprises at least a first polymer block component and a second polymer block component which are connected with each other. Examples of such a block copolymer include an A-B type block copolymer and an A-B-A type block copolymer in which a polymer block component “A” (a first polymer block component) having a repeating unit “a” and a polymer block component “B” (a second polymer block component) having a repeating unit “b” are connected end-to-end, having a structure—(aa . . . aa)-(bb . . . bb)—. The block copolymer may comprise three or more kinds of polymer block components and, for example, can be an A-B-C type block copolymer. The block copolymer can also be of a star type in which one or more kinds of polymer block components extend radially from a center, or of a type in which another polymer component is branched from a main chain of a block copolymer.

The kind of polymer block components are not particularly limited as long as they are immiscible to each other. Therefore, it is preferable that the block copolymer used in the production method of the present invention comprises polymer block components having different polarities. Examples of the block copolymer include polystyrene-block-poly(methyl methacrylate) (PS-b-PMMA), polystyrene-block-poly(ethylene oxide) (PS-b-PEO), polystyrene-block-polyvinylpyridine (PS-b-PVP), polystyrene-block-polyisoprene (PS-b-PI), polystyrene-block-polybutadiene (PS-b-PBD), polystyrene-block-poly(ferrocenyl dimethylsilane) (PS-b-PFS), poly(ethylene oxide)-block-poly(isoprene) (PEO-b-PI), poly(ethylene oxide)-block-polybutadiene (PEO-b-PBD), poly(ethylene oxide)-block-poly(methyl methacrylate) (PEO-b-PMMA), poly(ethylene oxide)-block-poly(ethyl ethylene) (PEO-b-PEE), polybutadiene-block-polyvinylpyridine (PBD-b-PVP), polyisoprene-block-poly(methyl methacrylate) (PI-b-PMMA), polystyrene-block-poly(acrylic acid) (PS-b-PAA), and polybutadiene-block-poly(methyl methacrylate) (PB-b-PMMA).

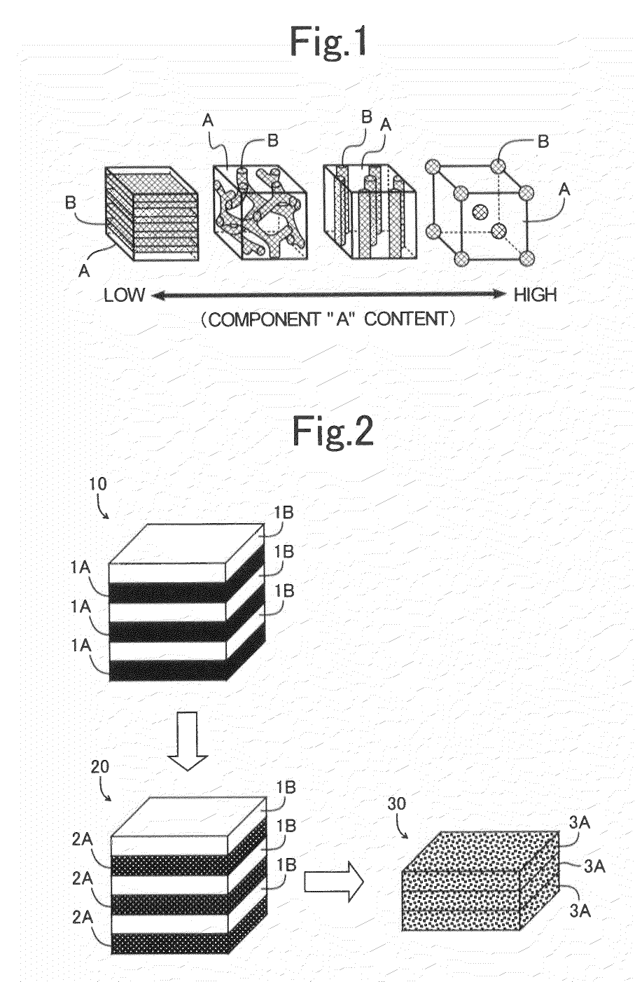

The molecular weight of the block copolymer and the polymer block components can be appropriately selected in accordance with structure scale and arrangement of a nanostructured material to be produced. For example, it is desirable to employ a block copolymer having a number average molecular weight of 100 to ten million, or 1000 to one million. As the average molecular weight is smaller, the structure scale is smaller (With a lamellar structure, the thickness of each layer is smaller). Moreover, with regards to the number average molecular weight of the respective polymer block components, by adjusting the molecular weight ratio of the respective polymer block components, a phase-separated structure to be obtained by self-assembly in the following nanostructure-forming step can be made into a desired structure, and accordingly a nanostructured material having a structure in which an inorganic precursor (or an inorganic component) is arranged in a desired form can be obtained. The phase-separated structure is influenced by not only the molecular weight ratio but also a product of solubility parameter multiplied by the degree of polymerization, and so on. When a phase-separated structure having a lamellar structure, for instance, is to be obtained, it is preferable that the molecular weight ratio of the polymer block component “A” and the polymer block component “B” (A:B) is 30:70 to 70:30 or 40:60 to 60:40 by number average molecular weight. Moreover, the nanophase-separated structure can be not only the structures shown in FIG. 1 but also “a spiral structure” obtained from an A-B-C type block copolymer having a phase “C” separated in a coil form in a boundary between a phase “A” and a phase “B” which form a cylindrical structure.

It is also preferable to employ a block copolymer which is easily decomposable by calcination or light irradiation or a block copolymer which can easily be removed with a solvent. In this case, employing a block copolymer comprising two or more kinds of polymer block components having different chemical resistances makes it possible to selectively remove only some polymer component in the subsequent block copolymer removal step.

The inorganic precursor is a compound which coordinates with the first polymer block component but does not coordinate with at least the second polymer block component. It is possible to additionally employ a second inorganic precursor which coordinates with at least the second polymer block component. That is to say, when the block copolymer is an A-B type, an inorganic precursor to be used can be an inorganic precursor which coordinates with only the polymer block component “A” and/or an inorganic precursor which coordinates with only the polymer block component “B”. When the block copolymer is an A-B-C type, it is possible to additionally use an inorganic precursor which coordinates with only a polymer block component “C”, if necessary, and it is also possible to use an inorganic precursor which coordinates with only “A” and “B”, only “B” and “C”, or only “A” and “C”. In any case, it is only necessary that a desired inorganic precursor is introduced in desired positions of a phase-separated structure to be obtained by self-assembly in the subsequent nanostructure-forming step. It is also possible to introduce plural kinds of inorganic precursors into one polymer block component.

When the block copolymer comprises a polar polymer block component which is a polar polymer and a nonpolar block component which is a nonpolar polymer, a polar inorganic precursor easily coordinates with the polar polymer block component and a nonpolar inorganic precursor easily coordinates with the nonpolar polymer block component. Therefore, the inorganic precursor can be either a polar inorganic precursor or a nonpolar inorganic precursor.

The kind of inorganic precursor is not particularly limited as long as it can be dissolved in a solvent together with the block copolymer, and it is possible to appropriately select and use a compound to be converted to a desired inorganic component. The inorganic precursor is preferably one or more selected from the group consisting of salts, alkoxides, and complexes. An inorganic component to be obtained after conversion is preferably one or more selected from the group consisting of oxides, metals, carbides, nitrides and borides. The oxides, carbides, nitrides and borides preferably contain at least one of iron (Fe), aluminum (Al), niobium (Nb), cobalt (Co), nickel (Ni), platinum (Pt), tellurium (Te), titanium (Ti) and other metals and silicon (Si). Accordingly, an inorganic precursor suitably employable in the production method of the present invention is at least one of salts such as carbonates, nitrates, phosphates, sulfates and chlorides containing the above element (s), alkoxides such as methoxides, ethoxides, propoxides and butoxides containing the above element(s), complexes such as acetylacetates containing the above element(s) such as Fe(acac)₃, Co(acac)₂, Pt(acac)₂ and Ni(acac)₂, and, in addition, metal organic compounds such as phenyltrimethoxysilane containing the above element(s).

It is noted that when the block copolymer and the inorganic precursor react with each other and form a chemical bond, a nanophase-separated structure is not formed and regular arrangement is not obtained. For example, when a polymer block component is polysilane, metal alkoxide is not desirable as an inorganic precursor because polysilane easily reacts with metal alkoxide. Coordination of the block copolymer and the inorganic precursor is a state in which both the block copolymer and the inorganic precursor are simply arranged in a molecular state or an ionic state.

The kind of solvent for dissolving the block copolymer and the inorganic precursor is not particularly limited. Examples of such a solvent include acetone, tetrahydrofuran (THF), toluene, propylene glycol monomethyl ether acetate (PGMEA), propylene glycol monomethyl ether (PGME), chloroform and benzene, but the solvent used in the present invention is not limited to these solvents. Of these solvents, one kind can be used singly or two or more kinds can be used by mixing them. Besides, when the production method of the present invention includes a step of coating the raw material solution on a surface of a substrate (“a coating step” mentioned later), it is preferable to select and use a solvent which does not deteriorate the substrate.

It is noted that in the description of the present invention “to dissolve” means a phenomenon that a substance (a solute) dissolves in a solvent to form a uniform mixture (a solution), and includes states in which, after dissolving the substance, at least part of the solute becomes ions, the solute is not dissociated into ions and exists in a molecular state, or the solute exists as associating molecules or ions.

The ratio of the solute (the block copolymer and the inorganic precursor and, if necessary, the second inorganic precursor) in the raw material solution is not particularly limited. It is noted that when the raw material solution is coated on a surface of a substrate, the total of the solute is preferably 0.1 to 30% by mass or 0.5 to 10% by mass based on the total weight of the raw material solution in order to provide the raw material solution with sufficient fluidity for coating. Moreover, since the amount of the inorganic component to be introduced can be controlled by adjusting the amount of the inorganic precursor used with respect to the amount of the block copolymer, the density of the inorganic component in a resulting nanostructured material and, if it is a lamellar structure, the thickness of each layer after removal of the organic component (“a block copolymer removal step” mentioned later) and so on can be controlled to desired levels.

[Nanostructure-Forming Step]

The nanostructure-forming step is a step of forming a nanophase-separated structure in which at least a first polymer phase comprising the first polymer block component with which the inorganic precursor is coordinated and a second polymer phase comprising the second polymer block component are regularly arranged by self-assembly.

The raw material solution prepared in the raw material solution preparation step contains the block copolymer and the inorganic precursor, and the inorganic precursor is coordinated with the first polymer block component of the polymer block components constituting the block copolymer. Therefore, when the block copolymer forms a nanophase-separated structure by self-assembly, the inorganic precursor can also be regularly arranged in predetermined positions in accordance with the nanophase-separated structure. Moreover, by converting the inorganic precursor arranged in the predetermined positions to an inorganic component, it becomes possible to obtain a nanostructured material comprising an organic component comprising the block copolymer and the inorganic component regularly arranged at the predetermined positions in the organic component (an organic/inorganic nanostructured material). Furthermore, by removing the block copolymer having the nanophase-separated structure, it is possible to remove the organic component from the organic/inorganic nanostructured material and form a nanostructured material comprising the inorganic component.

It is noted that the block copolymer can self-assemble and form a phase-separated structure by being subjected to a heat treatment at or above a glass transition temperature. Moreover, the inorganic precursor can be converted to the inorganic component by a method suitable for the kind. In either case, conventional methods can be used.

For example, an organic/inorganic nanostructured material can be easily obtained by carrying out a heat treatment at or above a temperature at which the block copolymer forms a nanophase-separated structure and the inorganic precursor is converted to the inorganic component in the nanostructure-forming step. Moreover, by carrying out calcination at or above a temperature at which the block copolymer having the nanophase-separated structure decomposes, phase separation of the block copolymer, conversion of the inorganic precursor to the inorganic component, and removal of the block copolymer can be all conducted in only one heat treatment. In order to complete even the removal of the block copolymer in only one heat treatment, the heat treatment is preferably carried out at 350 to 900° C. in the air, although heat treatment conditions may differ with the kind of the block copolymer and the inorganic precursor.

Moreover, the nanostructure-forming step can include a nanophase-separation treatment step of forming the nanophase-separated structure by applying a heat treatment to the block copolymer, and a precursor conversion step of converting the inorganic precursor to the inorganic component. In this case, the precursor conversion step can be a step of converting the inorganic precursor to the inorganic component by heating the inorganic precursor or a step of converting the inorganic precursor to the inorganic component by subjecting the inorganic precursor to hydrolysis and dehydration condensation.

Moreover, the nanostructure-forming step can further include a block copolymer removal step of removing the block copolymer having the nanophase-separated structure after the precursor conversion step. The block copolymer removal step can be a step of decomposing the block copolymer by calcination, a step of removing the block copolymer by dissolving the block copolymer in a solvent, or a step of decomposing the block copolymer by light irradiation such as ultraviolet irradiation. The calcination is desirably carried out in the air and calcination time and temperature can be selected in accordance with the kind of block copolymer. For dissolving the block copolymer, it is possible to use the same solvent as used in the raw material solution preparation step or a different solvent from that used in the raw material solution preparation step. Moreover, in the block copolymer removal step, removal of all the organic component comprising the block copolymer is possible, but removal of only part of the organic component is also possible by using a solvent which selectively dissolves some of the polymer block components.

Referring to FIG. 2, the nanostructure-forming step will be described below by way of an example in which a block copolymer forms a lamellar structure by self-assembly. FIG. 2 shows schematic views of nanostructured materials formed in the nanostructure-forming step.

When a raw material solution contains an A-B type block copolymer comprising a polymer block component “A” and a polymer block component “B” at a molecular weight ratio of A:B=1:1, and an inorganic precursor having affinity with the polymer block component “A”, the inorganic precursor coordinates with the polymer block component “A”. Therefore, by self-assembly of the block copolymer, it is possible to obtain a nanostructure “10” having a multilayered structure in which first layers “1A” which are a polymer phase comprising the polymer block component “A” and containing the inorganic precursor, and second layers “1B” which are a polymer phase comprising the polymer block component “B” are alternately layered. In this case, by converting the inorganic precursor to an inorganic component, it is possible to obtain an organic/inorganic nanostructured material “20” in which the inorganic component is introduced at predetermined positions “2A”. Furthermore, by removing the block copolymer, it is possible to obtain an inorganic nanostructure “30” in which layers “3A” comprising the inorganic component are laminated.

It is noted that the foregoing description has been made on the lamellar structure as an example but it goes without saying that the other structures described before are also applicable. Moreover, two kinds of inorganic precursors can be used and introduced to the first layers “1A” and the second layers “1B”, respectively.

[Coating Step]

The method of the present invention for producing a nanostructured material can further comprise a coating step of coating the raw material solution on a surface of a substrate, after the raw material solution preparation step. In the nanostructure-forming step after the coating step, a coating film comprising the nanostructured material is formed on the surface of the substrate. The kind of substrate is not particularly limited and can be appropriately selected in accordance with the purpose of a nanostructured material to be obtained. Moreover, the method for coating the raw material solution can be, for example, brush coating, spraying, dipping, spinning, and curtain flow coating.

As having mentioned in detail, the method of the present invention for producing a nanostructured material can easily produce a nanostructured material having arrangement, composition, structure scale and the like which cannot be achieved by the conventional production methods. Therefore, nanostructured materials produced by the present invention can be expected to obtain an interface increasing effect, a nanosize effect, a significant durability improvement when compared to the conventional nanostructured materials. Specifically speaking, the nanostructured materials produced by the present invention are expected to have 10 times or more of the relative permittivity and twice or three times of the magnetic force of a bulk material having no nanostructure. Therefore, the nanostructured materials produced by the production method of the present invention are useful as functional materials, for example, for piezoelectric materials, thermoelectric materials, secondary cells, fine ceramics, magnetic materials and optical devices.

The best mode for carrying out the method of the present invention for producing a nanostructured material has been described above, but the present invention is not limited to the abovementioned mode. Many modifications and variations of the present invention are possible without departing from the spirit and scope, as will be apparent to those skilled in the art.

### PREFERRED EMBODIMENTS OF THE PRESENT INVENTION

Hereinafter, the present invention will be described concretely, referring to preferred embodiments of the method of the present invention for producing a nanostructured material.

### First Preferred Embodiment

0.1 g of polystyrene-poly(methyl methacrylate) block copolymer (PS-b-PMMA) and 0.08 g of iron(III) chloride (FeCl₃) were dissolved in 5 mL of acetone, thereby obtaining a raw material solution <a raw material solution preparation step>. The obtained raw material solution was spin-cast on an Si substrate <a coating step>. It is noted that PS of PS-b-PMMA had a molecular weight of 85,000, and PMMA of PS-b-PMMA had a molecular weight of 91,000.

A heat treatment at 450° C. for three hours in the air was applied to the coated substrate, thereby applying a nanophase-separation treatment to PS-b-PMMA, converting iron chloride to iron oxide and removing PS-b-PMMA by decomposition. An iron oxide coating film was obtained on a surface of the Si substrate <a nanostructure-forming step>.

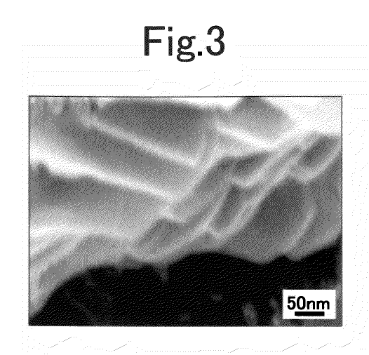

A cross section of the iron oxide coating film in the thickness direction was observed by a scanning electron microscope (SEM). An observation result is shown in FIG. 3. It was confirmed that the obtained coating film was a nanostructured material having a multi-layered structure. This is attributed to the fact that FeCl₃, which is a polar inorganic precursor, was coordinated with PMMA, which is a polar polymer block component, of PS-b-PMMA and that PS-b-PMMA formed a layered lamellar structure by self-assembly.

### Second Preferred Embodiment

0.1 g of polystyrene-poly(ethylene oxide) block copolymer (PS-b-PEO) and 0.15 g of aluminum butoxide were dissolved in 5 mL of tetrahydrofuran (THF), thereby obtaining a raw material solution. The obtained raw material solution was spin-cast on a Si substrate. It is noted that PS of PS-b-PEO had a molecular weight of 40,000 and PEO of PS-b-PEO had a molecular weight of 42,000.

A heat treatment at 450° C. for three hours in the air was applied to the coated substrate, thereby applying a nanophase-separation treatment to PS-b-PEO, converting aluminum butoxide to alumina and removing PS-b-PEO by decomposition. An alumina multi-layered film was obtained on a surface of the Si substrate.

### Third Preferred Embodiment

0.1 g of polystyrene-poly(ethylene oxide) block copolymer (PS-b-PEO) and 0.26 g of niobium butoxide were dissolved in 5 mL of tetrahydrofuran (THF), thereby obtaining a raw material solution. The obtained raw material solution was spin-cast on an Si substrate. It is noted that PS of PS-b-PEO had a molecular weight of 40,000 and PEO of PS-b-PEO had a molecular weight of 42,000.

A heat treatment at 450° C. for three hours in the air was applied to the coated substrate, thereby applying a nanophase-separation treatment to PS-b-PEO, converting niobium butoxide to niobium oxide and removing PS-b-PEO by decomposition. A niobium oxide multi-layered film was obtained on a surface of the Si substrate.

What is claimed is:

1. A method for producing a nanostructured material, comprising:
a raw material solution preparation step of preparing a raw material solution by dissolving, in a solvent, a block copolymer comprising at least a first polymer block component and a second polymer block component which are immiscible to each other, and an inorganic precursor which coordinates with the first polymer block component but does not coordinate with at least the second polymer block component; and
a nanostructure-forming step of forming a nanophase-separated structure in which at least a first polymer phase comprising the first polymer block component with which the inorganic precursor is coordinated, and a second polymer phase comprising the second polymer block component are regularly arranged by self-assembly.

2. The method according to claim 1, wherein the raw material solution preparation step is a step of further dissolving, in the solvent, a second inorganic precursor which coordinates with at least the second polymer block component.

3. The method according to claim 1, wherein the nanostructure-forming step is a step of converting the inorganic precursor to an inorganic component in addition to forming the nanophase-separated structure.

4. The method according to claim 3, wherein the nanostructure-forming step is a step of carrying out a heat treatment at or above a temperature at which the block copolymer forms the nanophase-separated structure and the inorganic precursor is converted to the inorganic component.

5. The method according to claim 4, wherein the nanostructure-forming step is a step of carrying out calcination at or above a temperature at which the block copolymer having the nanophase-separated structure decomposes.

6. The method according to claim 1, wherein the nanostructure-forming step includes a nanophase-separation treatment step of forming the nanophase-separated structure by applying a heat treatment to the block copolymer, and a precursor conversion step of converting the inorganic precursor to the inorganic component.

7. The method according to claim 6, wherein the precursor conversion step is a step of converting the inorganic precursor to the inorganic component by heating the inorganic precursor.

8. The method according to claim 6, wherein the precursor conversion step is a step of converting the inorganic precursor to the inorganic component by subjecting the inorganic precursor to hydrolysis and dehydration condensation.

9. The method according to claim 6, wherein the nanostructure-forming step further includes a block copolymer removal step of removing the block copolymer having the nanophase-separated structure after the precursor conversion step.

10. The method according to claim 9, wherein the block copolymer removal step is a step of decomposing the block copolymer by calcination.

11. The method according to claim 9, wherein the block copolymer removal step is a step of removing the block copolymer by dissolving the block copolymer in a solvent.

12. The method according to claim 9, wherein the block copolymer removal step is a step of decomposing the block copolymer by light irradiation.

13. The method according to claim 1, wherein the inorganic precursor is one or more selected from the group consisting of salts, alkoxides and complexes.

14. The method according to claim 13, wherein the nanostructure-forming step is a step of converting the inorganic precursor so as to generate, as the inorganic component, one or more selected from the group consisting of oxides, metals, carbides, nitrides and borides.

15. The method according to claim 1, wherein the block copolymer comprises a polar polymer block component which is a polar polymer and a nonpolar polymer block component which is a nonpolar polymer.

16. The method according to claim 15, wherein the inorganic precursor is a polar inorganic precursor which coordinates with the polar polymer block component, or a nonpolar inorganic precursor which coordinates with the nonpolar polymer block component.

17. The method according to claim 1, further comprising a coating step of coating the raw material solution on a surface of a substrate, after the raw material solution preparation step.

18. The method according to claim 1, wherein the nanophase-separated structure is a lamellar structure.

19. The method according to claim 1, wherein the nanophase-separated structure is a cylindrical structure.

20. The method according to claim 1, wherein the nanophase-separated structure is a dot structure.

21. A nanostructured material produced by the method according to claim 1.
